(19) United States
(12) Patent Application Publication
(10) Pub. No.: US 2015/0201401 A1
(43) Pub. Date: Jul. 16, 2015

(54) RADIO RESOURCE RESERVATION IN FRAMED COMMUNICATION SYSTEM

(71) Applicants: Eeva Lahetkangas, Oulu (FI); Esa Tapani Tiirola, Kempele (FI); Kari Pekka Pajukoski, Oulu (FI)

(72) Inventors: Eeva Lahetkangas, Oulu (FI); Esa Tapani Tiirola, Kempele (FI); Kari Pekka Pajukoski, Oulu (FI)

(73) Assignee: Nokia Solutions and Networks Oy, Espoo (FI)

(21) Appl. No.: 14/406,197

(22) PCT Filed: Jun. 8, 2012
(86) PCT No.: PCT/EP2012/060916

§ 371 Date: Feb. 2, 2015

(51) Int. Cl. H04W 72/04

(52) U.S. Cl. CPC H04W 72/04

(57) ABSTRACT

This document discloses a solution for carrying out radio resource reservation in a framed wireless network. A network node is synchronized to a frame structure of the wireless network, wherein the frame structure comprises a continuous flow of consecutive frames, wherein at least one frame comprises a downlink part and an uplink part, and wherein lengths of the downlink part and the uplink part in each frame are adjustable. A radio resource for use in data transmission between two network nodes is reserved through a radio resource reservation request-response procedure between the network nodes.

### RELATED APPLICATION

This application is a national stage entry of PCT Application No. PCT/EP2012/060916, filed on Jun. 8, 2012, entitled “RADIO RESOURCE RESERVATION IN FRAMED COMMUNICATION SYSTEM”, which is hereby incorporated by reference in its entirety.

### FIELD

The invention relates to the field of radio communications and, particularly, to reserving radio resources in a communication system where network nodes are synchronized to each other.

### BACKGROUND

Many modern cellular communication systems employ a framed transmission where base stations or access points provide a continuous frame structure defining a time reference for user terminals. Radio resources such as frequency resources are allocated to frames or sub-frames of this framed structure, and the access points may schedule the radio resource by referring to the time reference of the frame structure. The user terminals may be synchronized to the access points in order to keep track of the time reference.

### BRIEF DESCRIPTION

According to a first aspect of the invention, there is provided a method comprising:
causing a network node to synchronize to a frame structure of a wireless network, wherein the frame structure comprises a continuous flow of consecutive frames, wherein at least one frame comprises a downlink part and an uplink part, and wherein lengths of the downlink part and the uplink part in each frame are adjustable;
determining transmission resources for a radio resource reservation request in a frame of the frame structure;
causing transmission of the radio resource reservation request from the network node in the determined transmission resources, wherein the radio resource reservation request comprises an identifier of the network node and an identifier of a recipient node of the radio resource reservation request;
acquiring a radio resource reservation acknowledgment originated from the recipient node of the radio resource reservation request, wherein the radio resource reservation acknowledgment acknowledges reservation of radio resources for data transmission;
and in response to the radio resource reservation acknowledgment, causing data transmission in the reserved radio resources.

Each frame may comprise a protected part and a non-protected part, wherein the protected part comprises dedicated resources for uplink transmission from user terminals to access points, for downlink transmission from access points to user terminals, for radio resource reservation requests, and for radio resource reservation acknowledgments.

All active user terminals may be obliged to carry out reception in the downlink transmission resources of the protected part, and wherein a subset of active user terminals may be configured to carry out reception in the uplink transmission resources of the protected part.

At least one of the frames may comprise a plurality of protected parts and a plurality of non-protected parts.

The method may further comprise:
providing a radio link between the network node and a plurality of other network nodes; and
selecting the recipient node from the plurality of other network nodes with which the radio link has been established.

The plurality of other network nodes may comprise at least one access point and at least one user terminal.

The reserved radio resources may be used for bidirectional data transmission.

The guard intervals may be arranged at the beginning and at the end of the radio resource reservation request, wherein the guard intervals are preferably longer than corresponding guard intervals of at least one other control message transmitted by the network node.

The radio resource reservation acknowledgment may be acquired during the same frame as used in the transmission of the radio resource reservation request.

The data transmission may be arranged to occur in the same frame in which the radio resource reservation acknowledgment is transferred.

The radio resource reservation acknowledgment may be acquired in a frame subsequent to the frame in which the radio resource reservation request is transmitted.

The radio resource reservation request may further comprise an information element indicating radio resources requested for reservation, wherein the radio resource reservation request acknowledges whether or not the requested radio resources have been reserved for the data transmission, and wherein the actual radio resource reservation may be realized by the radio resource reservation acknowledgment.

The method may further comprise detecting a need for downlink data transmission from the network node to the recipient node and a need for uplink data transmission from a transmitter node to said network node; and arranging a transmission resource for said radio resource reservation acknowledgment from the recipient node and a transmission resource for a radio resource reservation request from the transmitter node to overlap at least partially.

Said identifier of the network node and the identifier of the recipient node may be explicit identifiers contained in the reservation request message.

Said identifier of the network node and the identifier of the recipient node may be indicated implicitly by transmitting the radio resource reservation request in a determined radio resource associated beforehand with communication between the network node and the recipient node.

According to a second aspect of the invention, there is provided a method comprising:
causing a network node to synchronize to a frame structure of a wireless network, wherein the frame structure comprises a continuous flow of consecutive frames, wherein at least one frame comprises a downlink part and an uplink part, and wherein lengths of the downlink part and the uplink part in each frame are adjustable;
determining transmission resources for a radio resource reservation request in a frame of the frame structure;
acquiring a radio resource reservation request originated from a transmitter node and transferred in the determined transmission resources, wherein the radio resource reservation request comprises an identifier of the network node and an identifier of the transmitter node;
causing transmission of a radio resource reservation acknowledgment to the transmitter node in response to the acquired radio resource reservation request, wherein the radio resource reservation acknowledgment acknowledges reservation of radio resources for data transmission;
and in response to the radio resource reservation acknowledgment, causing data reception in the reserved radio resources.

Each frame may comprise a protected part and a non-protected part, wherein the protected part comprises dedicated resources for uplink transmission from user terminals to access points, for downlink transmission from access points to user terminals, and for radio resource reservation requests.

All active user terminals may be obliged to carry out reception in the downlink transmission resources of the protected part, and wherein a subset of active user terminals is configured to carry out reception in the uplink transmission resources of the protected part.

At least one of the frames may comprise a plurality of protected parts and a plurality of non-protected parts.

The reserved radio resources may be used for bidirectional data transmission.

The method may further comprise attempting the transmission of the radio resource reservation acknowledgment in the same frame in which the radio resource reservation request was transferred.

The data reception may be arranged to occur in the same frame in which the radio resource reservation acknowledgment is transferred.

The method may further comprise causing the transmission of the radio resource reservation acknowledgment in a frame subsequent to the frame in which the radio resource reservation request was transferred.

The radio resource reservation request may further comprises an information element indicating radio resources requested for reservation, wherein the radio resource reservation request acknowledges whether or not the requested radio resources have been reserved for the data transmission, and wherein the actual radio resource reservation is realized by the radio resource reservation acknowledgment.

The radio resource reservation request may comprise an information element specifying the radio resources requested for reservation, and the method may further comprise:
determining whether or not the requested radio resources are available for reservation from the point of view of the network node;
if the requested radio resources are available for reservation from the point of view of the network node, acknowledging the reservation of the requested resources with the radio resource reservation acknowledgment message;
if only part of the requested radio resources are available for reservation from the point of view of the network node, acknowledging the reservation of the available resources with the radio resource reservation acknowledgment message and specifying the reserved radio resources in the radio resource reservation acknowledgment message.

The method may further comprise:
autonomously selecting the radio resources for reservation in the network node;
and specifying the reserved radio resources to the transmitter node in the radio resource reservation acknowledgment message.

Said identifier of the network node and the identifier of the transmitter node may be explicit identifiers contained in the reservation request message.

Said identifier of the network node and the identifier of the transmitter node may be indicated implicitly by a radio resource in which the radio resource reservation request has been transferred, wherein the radio resource has been associated beforehand with communication between the transmitter node and the network node.

The radio resource reservation according to the first or the second aspect may be static or semi-static lasting over a plurality of data transmissions.

According to a third aspect of the invention, there is provided an apparatus comprising at least one processor; and at least one memory including a computer program code, wherein the at least one memory and the computer program code are configured, with the at least one processor, to cause the apparatus to:
cause a network node to synchronize to a frame structure of a wireless network, wherein the frame structure comprises a continuous flow of consecutive frames, wherein at least one frame comprises a downlink part and an uplink part, and wherein lengths of the downlink part and the uplink part in each frame are adjustable;
determine transmission resources for a radio resource reservation request in a frame of the frame structure;
cause transmission of the radio resource reservation request from the network node in the determined transmission resources, wherein the radio resource reservation request comprises an identifier of the network node and an identifier of a recipient node of the radio resource reservation request;
acquire a radio resource reservation acknowledgment originated from the recipient node of the radio resource reservation request, wherein the radio resource reservation acknowledgment acknowledges reservation of radio resources for data transmission;
and in response to the radio resource reservation acknowledgment, cause data transmission in the reserved radio resources.

Each frame may comprise a protected part and a non-protected part, wherein the protected part comprises dedicated resources for uplink transmission from user terminals to access points, for downlink transmission from access points to user terminals, for radio resource reservation requests, and for radio resource reservation acknowledgments.

All active user terminals may be obliged to carry out reception in the downlink transmission resources of the protected part, and wherein a subset of active user terminals is configured to carry out reception in the uplink transmission resources of the protected part.

At least one of the frames may comprise a plurality of protected parts and a plurality of non-protected parts.

The at least one memory and the computer program code may be configured, with the at least one processor, to cause the apparatus further to:
provide a radio link between the network node and a plurality of other network nodes; and
select the recipient node from the plurality of other network nodes with which the radio link has been established.

The plurality of other network nodes may comprise at least one access point and at least one user terminal.

The reserved radio resources may be used for bidirectional data transmission.

The at least one memory and the computer program code may be configured, with the at least one processor, to cause the apparatus further to insert guard intervals at the beginning and at the end of the radio resource reservation request, wherein the guard intervals are preferably longer than corresponding guard intervals of at least one other control message transmitted by the network node.

The radio resource reservation acknowledgment may be acquired during the same frame as used in the transmission of the radio resource reservation request.

The at least one memory and the computer program code may be configured, with the at least one processor, to cause the apparatus further to arrange the data transmission to occur in the same frame in which the radio resource reservation acknowledgment is transferred.

The radio resource reservation acknowledgment may be acquired in a frame subsequent to the frame in which the radio resource reservation request is transmitted.

The radio resource reservation request may further comprise an information element indicating radio resources requested for reservation, wherein the radio resource reservation request acknowledges whether or not the requested radio resources have been reserved for the data transmission, and wherein the actual radio resource reservation may be realized by the radio resource reservation acknowledgment.

The at least one memory and the computer program code may be configured, with the at least one processor, to cause the apparatus further to:
detect a need for downlink data transmission from the network node to the recipient node and a need for uplink data transmission from a transmitter node to said network node; and
arrange a transmission resource for said radio resource reservation acknowledgment from the recipient node and a transmission resource for a radio resource reservation request from the transmitter node to overlap at least partially.

Said identifier of the network node and the identifier of the recipient node may be explicit identifiers contained in the reservation request message.

The at least one memory and the computer program code may be configured, with the at least one processor, to cause the apparatus further to indicate said identifier of the network node and the identifier of the recipient node implicitly by causing the transmission of the radio resource reservation request in a determined radio resource associated beforehand with communication between the network node and the recipient node.

According to a forth aspect of the invention, there is provided an apparatus comprising at least one processor; and at least one memory including a computer program code, wherein the at least one memory and the computer program code are configured, with the at least one processor, to cause the apparatus to:
cause a network node to synchronize to a frame structure of a wireless network, wherein the frame structure comprises a continuous flow of consecutive frames, wherein at least one frame comprises a downlink part and an uplink part, and wherein lengths of the downlink part and the uplink part in each frame are adjustable;
determine transmission resources for a radio resource reservation request in a frame of the frame structure;
acquire a radio resource reservation request originated from a transmitter node and transferred in the determined transmission resources, wherein the radio resource reservation request comprises an identifier of the network node and an identifier of the transmitter node;
cause transmission of a radio resource reservation acknowledgment to the transmitter node in response to the acquired radio resource reservation request, wherein the radio resource reservation acknowledgment acknowledges reservation of radio resources for data transmission;
and in response to the radio resource reservation acknowledgment, cause data reception in the reserved radio resources.

Each frame may comprise a protected part and a non-protected part, wherein the protected part comprises dedicated resources for uplink transmission from user terminals to access points, for downlink transmission from access points to user terminals, and for radio resource reservation requests.

All active user terminals may be obliged to carry out reception in the downlink transmission resources of the protected part, and wherein a subset of active user terminals is configured to carry out reception in the uplink transmission resources of the protected part.

At least one of the frames may comprise a plurality of protected parts and a plurality of non-protected parts.

The at least one memory and the computer program code may be configured, with the at least one processor, to cause the apparatus further to use the reserved radio resources for bidirectional data transmission.

The at least one memory and the computer program code may be configured, with the at least one processor, to cause the apparatus further to attempt the transmission of the radio resource reservation acknowledgment in the same frame in which the radio resource reservation request was transferred.

The at least one memory and the computer program code may be configured, with the at least one processor, to cause the apparatus further to arrange the data reception to occur in the same frame in which the radio resource reservation acknowledgment is transferred.

The at least one memory and the computer program code may be configured, with the at least one processor, to cause the apparatus further to cause the transmission of the radio resource reservation acknowledgment in a frame subsequent to the frame in which the radio resource reservation request was transferred.

The radio resource reservation request may further comprise an information element indicating radio resources requested for reservation, wherein the radio resource reservation request acknowledges whether or not the requested radio resources have been reserved for the data transmission, and wherein the actual radio resource reservation may be realized by the radio resource reservation acknowledgment.

The radio resource reservation request may comprise an information element specifying the radio resources requested for reservation, and the at least one memory and the computer program code may be configured, with the at least one processor, to cause the apparatus further to:
determine whether or not the requested radio resources are available for reservation from the point of view of the network node;
if the requested radio resources are available for reservation from the point of view of the network node, acknowledge the reservation of the requested resources with the radio resource reservation acknowledgment message;
if only part of the requested radio resources is available for reservation from the point of view of the network node, acknowledge the reservation of the available resources with the radio resource reservation acknowledgment message and specify the reserved radio resources in the radio resource reservation acknowledgment message.

The at least one memory and the computer program code may be configured, with the at least one processor, to cause the apparatus further to:
autonomously select the radio resources for reservation in the network node; and
specify the reserved radio resources to the transmitter node in the radio resource reservation acknowledgment message.

Said identifier of the network node and the identifier of the transmitter node may be explicit identifiers contained in the reservation request message.

The at least one memory and the computer program code may be configured, with the at least one processor, to cause the apparatus further to indicate said identifier of the network node and the identifier of the transmitter node implicitly by a radio resource in which the radio resource reservation request has been transferred, wherein the radio resource has been associated beforehand with communication between the transmitter node and the network node.

The radio resource reservation may be static or semi-static lasting over a plurality of data transmissions.

According to a fifth aspect of the invention there is provided a computer program product embodied on a distribution medium readable by a computer and comprising program instructions which, when loaded into an apparatus, execute a method according to the first and the second aspect.

### LIST OF DRAWINGS

Embodiments of the present invention are described below, by way of example only, with reference to the accompanying drawings, in which

FIG. 1 illustrates wireless communication scenario to which embodiments of the invention may be applied;

FIG. 2 illustrates a radio resource reservation procedure according to an embodiment of the invention;

FIG. 3 illustrates an embodiment of a flexible frame structure according to an embodiment of the invention;

FIGS. 4 and 5 illustrate radio resource reservation procedure according to some embodiments of the invention;

FIGS. 6 and 7 illustrate radio resource reservation and associated data transmission according to some embodiments of the invention;

FIG. 8 illustrates an embodiment of a frame structure according to another embodiment of the invention;

FIG. 9 illustrates another wireless communication scenario;

FIG. 10 illustrates an embodiment of a radio resource reservation procedure applicable to the scenario of FIG. 9; and

FIG. 11 is a block diagram of an apparatus according to an embodiment of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

FIG. 1 illustrates a wireless communication environment to which embodiments of the invention may be applied. In a modern communication scenario illustrated in FIG. 1, nodes of a wireless network may communicate simultaneously with several other nodes. The other nodes may belong to different wireless networks or be individual radio devices not currently belonging to any wireless network. The nodes illustrated in FIG. 1 comprise access points 104, 120, 122 providing radio access within their respective coverage areas 100, 101, 102. The coverage areas are called cells in connection with cellular communication systems such as Universal Mobile Telecommunication System (UMTS) and its evolution versions LTE (Long-term Evolution) and LTE-Advanced. The access points 104, 120, 122 may provide user terminals 110, 112, 114 with access to other networks and to the Internet, for example.

In addition to communicating with one or more access points 104, 120, 122, at least some of the user terminals 120 to 124, may be configured to establish device-to-device (D2D) communication links with other user terminals. The D2D links may be defined as direct connections between user terminals 120 to 124 without routing any data through an access point. In other words, a physical layer connection over the air interface may be provided between the user terminals. The D2D connections may utilize radio resources of at least one of the access points 104 and, thus, the user terminals may belong to the wireless network such an access point in order to exchange control signalling with the access point for radio resource control purposes.

Additionally, the access points 104, 120, 122 may communicate directly with one another by establishing AP2AP or physical layer radio connections between the access points.

It is thus possible to realize local area networks within the resources of a wide area network such as the UMTS. Unlike a wide area cellular system, the local area system can utilize local-access-only frequency bands, offer possibility to use the D2D operation mode, and establish ad-hoc networks. Possible features of such a local area network may further include distributed resource allocation between neighboring access points 104, 120, 122 and user terminals 110 to 114. In this kind of scenario, an access point may determine a master frame format to which other network nodes synchronize and assign radio resources to the other network nodes that may then themselves carry out actual scheduling and resource allocation in distributed and, optionally, contention based manner. This may decrease scheduling load and scheduling delays compared to a situation where the access point carries out centralized scheduling of the radio resources. Additionally it may provide fast direct access to a transmission medium by the network nodes. It is also possible to provide support for flexible spectrum usage (FSU) on shared frequency spectrum, wherein operators of different networks may exchenge information only via over-the-air between the network nodes of different networks or operators.

Embodiments of the invention relate to a wireless network where network nodes, e.g. nodes 104 to 122 are synchronized to a common time reference which defines a continuous frame structure of the wireless network. The frame structure may be a frame structure of a cellular communication system, e.g. an LTE-Advanced system or even more evolved system. The system may utilize time-division duplexing in which both uplink and downlink resources are allocated to the same frequency band but are allocated with different transmission timings. The system may further utilize half-duplex communication in which a network node may only transmit or receive at a time.

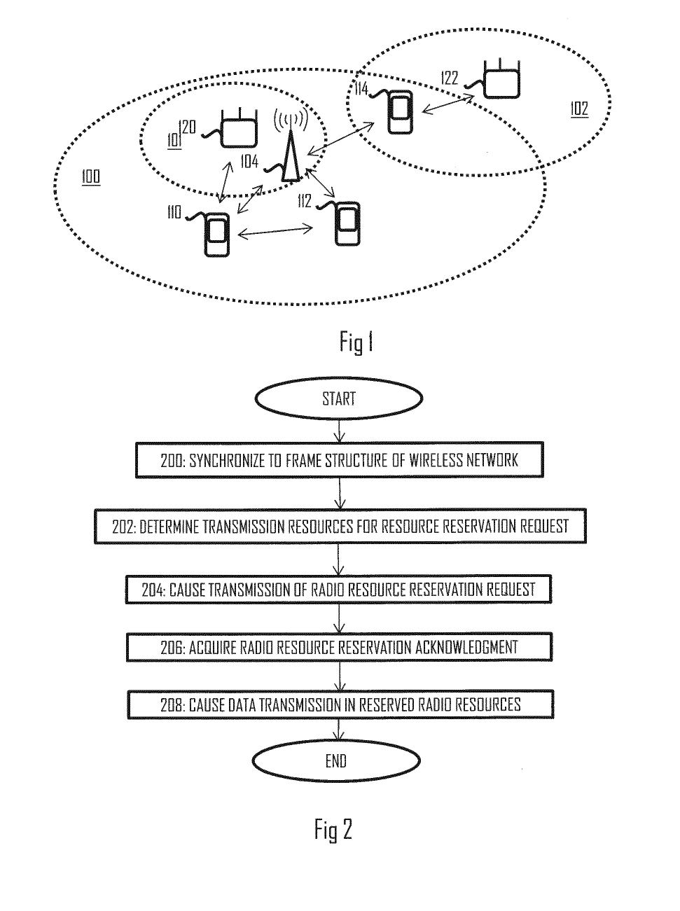

FIG. 2 illustrates a flow diagram of a radio resource reservation procedure an embodiment of the invention. The procedure may be carried out in any one of the network nodes 104 to 122. Referring to FIG. 2, the network node is configured to synchronize to a frame structure of a wireless network in block 200. The frame structure comprises a continuous flow of consecutive frames, wherein at least one frame comprises a downlink part and an uplink part. Some of the frames may comprise the downlink part and the uplink part, while some of the frames comprise only a downlink part or an uplink part. Most of the frames may comprise the downlink part and the uplink part. The lengths of the downlink part and the uplink part in each frame are adjustable. The uplink part and the downlink part may be separated in time.

In block 202, transmission resources for a radio resource reservation request in a frame of the frame structure are determined. In other words, a transmission timing and transmission frequency resources of the request may be determined in block 202.

Upon determining the transmission resources for the radio resource reservation request, transmission of the radio resource reservation request from the network node is arranged to occur in the determined transmission resources in block 204. The radio resource reservation request comprises an identifier of the network node (the transmitter) and an identifier of a recipient node of the radio resource reservation request. As a consequence, the network node indicates a request to carry out data transmission with the recipient node and requests the recipient node to reserve radio resources for the data transmission.

In block 206, a radio resource reservation acknowledgment originated from the recipient node of the radio resource reservation request is acquired in the network node that transmitted the radio resource reservation request. The radio resource reservation acknowledgment acknowledges the reservation of radio resources for the data transmission. In response to the radio resource reservation acknowledgment, the data transmission is carried out in the reserved radio resources in block 208.

This embodiment thus provides a radio resource reservation request/response procedure in a framed network. The request/response handshake may be carried out between arbitrary nodes of the wireless network, e.g. between access points, between an access point and a user terminal, or between user terminals. The procedure provides the transmitter node with a fast radio resource reservation procedure to transmit data to an arbitrary recipient node, and signalling overhead in the wireless network may be reduced.

In an embodiment, the identifiers of the nodes are comprised as explicit identifiers comprised as information elements in the radio resource reservation request message, e.g. cellular network identifiers or device-to-device connection identifier(s). In another embodiment, the identifiers are indicated implicitly as a radio resource in which the radio resource reservation request is communicated. For example, the radio resource may be dedicated for exchange of the radio resource reservation request between a specific pair of network nodes. The network node transmitting the request may determine the recipient node and select the radio resource for the request message accordingly, while the recipient node may be configured to monitor for one or more radio resources and, upon detecting the radio resource reservation request message in a radio resource, it may determine which network node is associated with that particular radio resource. Thus, the radio resource may serve in the identification of the transmitter-recipient pair.

In an embodiment, the transmission resource of the radio resource reservation request may be comprised in a single orthogonal frequency division multiple access (OFDMA) symbol of the protected part of the frame. The transmission resource may comprise a subset of sub-carriers of the OFDMA symbol.

In an embodiment, the resources available for resource reservation are common for multiple network nodes. This embodiment may involve contention based contention based resource reservation.

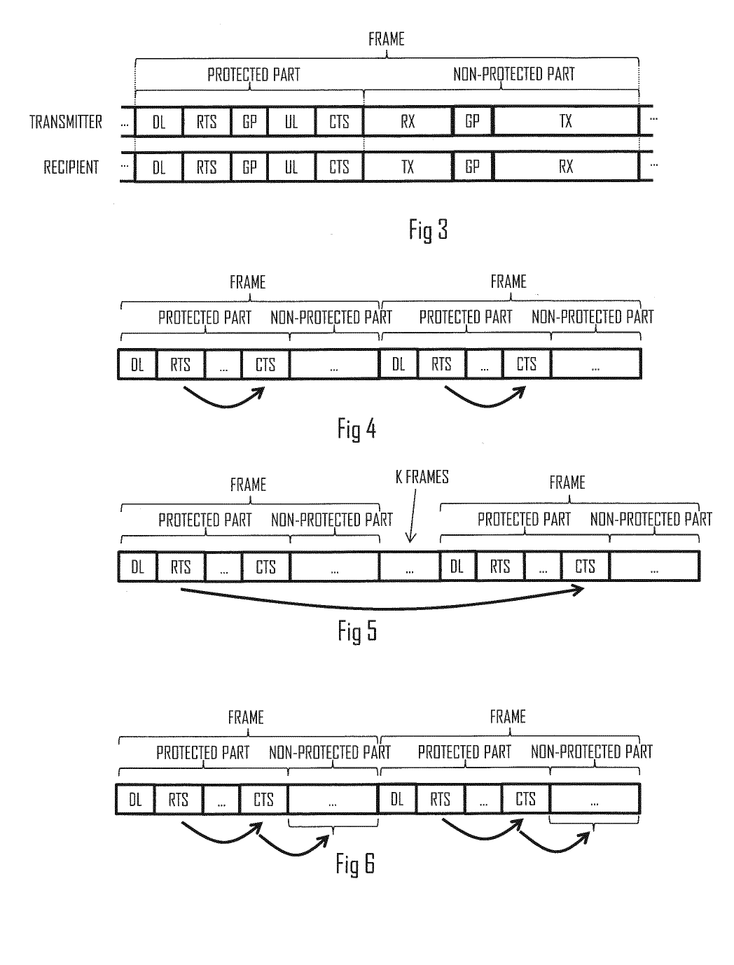

FIG. 3 illustrates an embodiment of the frame structure of the wireless network. As mentioned above, the frame structure may comprise a continuous sequence of consecutive frames, and communication resources may be mapped to a time reference provided by the frame structure. By synchronizing to the wireless network, e.g. to a master access point of the wireless network, the network nodes also synchronize to the time reference of the frame structure and are able to determine the communication resources from this time reference.

Referring to FIG. 3, each frame may comprise the downlink part and the uplink part. The downlink part may be reserved for downlink communications from the access point(s) to the user terminal(s), while the uplink part may be reserved for uplink communications from the user terminal(s) to the access point(s). The communication may comprise data and/or control messages. With respect to the D2D communication between the user terminals and between the access points, the terms uplink and downlink may be configured from the point of view of the device transmitting the radio resource reservation request. Accordingly, the radio resources of the uplink part may be reserved for transmission of the data to the recipient node, while the radio resources of the downlink part may be reserved for reception of the data from the recipient node (in case the transmitter node reserves the resources also for the data reception). However, it should be appreciated that equally the terms uplink and downlink may be configured from the point of view of the recipient node.

The frame may further comprise a protected part and a non-protected part. The protected part may comprise at least one downlink part (DL), and all active user terminals may be configured to carry out reception during the downlink part of the protected part. Term “active” may be understood to refer to a user terminal in an active state, e.g. in a radio resource connected state. Accordingly, no active user terminal may reserve a downlink part of the protected part for the transmission of its own. This ensures that all user terminals receive any important control information from the access point(s). This type of controlled transmission reduces cross-link interference, e.g. uplink or D2D transmissions do not interfere with downlink transmissions. Similarly, the protected part may comprise an uplink part (UL) in which all the access points may be configured to carry out reception, and the user terminals may transmit any important control information or data to the access point(s). In some embodiments, resources of the uplink part of the protected part may be reserved for D2D transmissions, and at least a subset of active user terminals may be configured to carry out transmission in the uplink part of the protected part while another subset of active user terminals may be configured to carry out reception in the uplink part of the protected part. A guard period (GP) may be provided during the transition from the downlink part to the uplink part.

The non-protected part may also comprise the uplink part and the downlink part or, in some embodiments or situations, only a downlink part or the uplink part. In FIG. 3, a downlink part precedes the uplink part in the non-protected part, and a guard period may be provided between the transition from the downlink to the uplink. The downlink part and the uplink part of the non-protected part of the frame may be determined from the point of view of the transmitter node and the recipient node. As shown in FIG. 3, the transmitter may reserve resources from the downlink part for reception of data from the recipient node, while the resources of the uplink part may be reserved for transmission of data from the transmitter node to the recipient node. The portions of the downlink part and the uplink part of the protected part may be static or semi-static, while the portions of the downlink part and the uplink part of the non-protected part may be configured dynamically according to the respective needs of the network nodes to communicate uplink and downlink data and D2D data. The master access point may configure the portions of the downlink part and the uplink part frame-by-frame or in a bundle of multiple frames as a part of system configuration. Corresponding control information may be distributed to the network nodes as a part of system information in the protected part of the frames.

The transmission resources of the radio resource reservation messages (request and acknowledgment) may be assigned to the protected part of the frame. In an embodiment, the radio resources of the radio resource reservation request message(s) (RTS) precede the radio resources of the radio resource reservation acknowledgment message(s) (CTS) in time in the protected part, as shown in FIG. 3. The protected part may comprise a time interval dedicated only for the transmission of the RTS messages, and another time interval dedicated only for the transmission of the CTS messages. Thus, interference from other transmissions towards the RTS/CTS handshake is also reduced. The transmission resources of the RTS/CTS messages may be dynamically allocated, or they may be semi-static parameters signalled by the master access point as a part of the system information, or it may be a default parameter defined by a specification of the wireless network. In the latter case, the resources of the RTS/CTS messages are provided beforehand as default parameters in each network node.

In addition to transmitting the RTS/CTS messages in the corresponding resources, when necessary, each network node may be configured to scan for at least the RTS resources in order to detect any RTS message assigned to the network node.

In an embodiment, separate radio resources are dedicated to the RTS and CTS messages. In another embodiment, the same radio resources are dedicated to the RTS and CTS messages. For example, the same frequency resources may be dedicated to the RTS and CTS messages, while the time intervals dedicated to the RTS and CTS messages may differ from one another. In another example, even the same time interval is dedicated to the RTS and CTS messages, and both CTS and RTS messages may be transmitted in both RTS and CTS resources of FIG. 3.

In an embodiment, the transmission of the RTS message does not trigger the reservation of the radio resources, while the transmission of the CTS messages carries out the actual reservation. As a consequence, the transmitter node may simply request for the reservation of the resources, while the recipient node actually determines whether or not to reserve the resources, and it may indicate the successful or failed reservation of the resource in the CTS message. The transmitter node may determine the requested radio resources from its point of view, e.g. it may request for reservation of only those resources that are not currently reserved from its point of view. The recipient node may correspondingly check whether or not the requested radio resources have already been reserved, as observed by the recipient node. Note that the recipient node may have detected a resource reservation not detected by the transmitter node. Any other network node detecting the CTS message and the reservation may suspend its transmission on the reserved radio resources.

In an embodiment, the transmitter node may acknowledge the reception of the CTS message by transmitting an acknowledgment message (ACK) to the recipient node. The protected part may comprise radio resources dedicated for transmission of the acknowledgment messages, and the radio resources for the acknowledgment messages may follow the resources of the CTS messages in time.

In an embodiment, the network nodes may acquire a transmission opportunity to transmit the RTS, CTS and, optionally, the ACK messages through channel contention. For example, the radio resources of the RTS, CTS, and ACK messages may be shared resources to which any network node may gain access. Each network node may be configured to sense the radio resources for a determined duration defined by a backoff timer, for example. Different network nodes may employ different backoff timer durations to ensure that collisions are avoided. Upon detecting no transmission within that duration, the network node may carry out the transmission. The radio resources of the RTS, CTS, and ACK messages may comprise resources for transmitting a plurality of corresponding messages within the time interval the corresponding radio resources are available.

In another embodiment, an access point may schedule the RTS and CTS resources to the network nodes in order to avoid collisions. In yet another embodiment, at least some of the network nodes have a semi-persistent resource allocation to an RTS and/or CTS resource. This ensures that a network node needing high data transfer capacity is able to negotiate resource reservation without collisions.

In an embodiment, guard intervals are arranged at the beginning and at the end of the radio resource reservation request. The guard intervals may be longer than corresponding guard intervals of at least one other control message transmitted by the network node. The extra-long guard interval allocated to the RTS message ensures that the RTS message does not interfere with any other transmissions. There may be situations where the network node transmits the RTS message while being somewhat out of synchronization with the frame timing, e.g. after a long idle period, and the longer guard period avoids interference caused by the sub-optimal synchronization.

In an embodiment, the poor synchronization may be corrected during the RTS/CTS handshake. For example, the RTS message may comprise a synchronization signal. The recipient node may determine the degree of unsynchronization between the transmitter node and the network from the received synchronization signal and insert into the CTS message a timing control signal instructing the transmitter node to adjust its timing appropriately. This provides for a fast resynchronization procedure in connection with the radio resource reservation.

Let us now describe some embodiments for arranging the radio resource reservation handshake between the transmission node and the recipient node with reference to FIGS. 4 and 5.

Referring to FIG. 4, the CTS message may be configured to be transmitted in the same frame or even in the same protected part of the frame in which the RTS message was received. There may be an offset between the time intervals of the RTS and CTS resources to take into account the propagation and processing delays associated with the RTS message.

Referring to FIG. 5 illustrating an embodiment where the recipient node is provided with more time to process the RTS message, a determined frame offset may be configured between the RTS message and the CTS message. As a consequence, the CTS message may be transmitted in a determined frame following the frame in which the RTS message was transmitted. This frame offset may be fixed, or the frame offset may be determined as a maximum frame offset allowed for the CTS message. In the former case, the recipient node may wait for the determined duration defined in the number of frames and counted from the frame of the RTS message before it may attempt transmission of the CTS message in the appropriate CTS resources of the correct frame. In the latter embodiment, the recipient node may attempt the transmission of the CTS message as soon as it has processed the RTS message, determined the availability of the requested radio resources, and prepared the CTS message for the transmission. If it does not gain channel access during the first CTS resources available, it may wait for the CTS resources of the next frame until the maximum frame offset is reached. Similarly, the transmitter of the RTS message may wait for the reception of the CTS message for a predetermined duration and, upon reception of no CTS message within that time duration, it may restart the radio resource reservation procedure.

The RTS message may comprise at least the identifier of the transmitter of the RTS message and the identifier of the recipient node to indicate the request to transmit data to the recipient node. The RTS message may also comprise an information element specifying the radio resources that are requested for reservation. This information element may comprise a code word that specifies which physical resource blocks (PRB) and/or transmission time intervals are requested for reservation. The PRB may be defined as a frequency resource block. Furthermore, the RTS message may comprise an information element indicating a reason for transmitting the RTS message. A typical reason is to transmit data, but the RTS message may also be used in connection with cell (re)selection procedure, and the transmitter node may address the RTS message to an access point of a new cell to which the transmitter node wishes to associate. The RTS message may further comprise an information element indicating a buffer status of the transmitter node, e.g. amount of data in the buffer. This may replace the information element specifying the radio resource requested for reservation, as in some embodiments the recipient node needs only know how much data transfer capacity the transmitter node requires, and it may make the reservation on that basis. The RTS message may further comprise an information element indicating information related to collision handling and avoidance, e.g. backup resources in case of collisions. The RTS message may further comprise a pilot signal used for channel estimation or synchronization, for example.

The CTS message may also comprise the identifier of the transmitter node and the recipient node. The CTS message may also comprise an information element indicating the reserved resources, e.g. the reserved PRB(s) and the frame(s) or sub-frame(s). The other network nodes may also read the contents of the CTS message in order to determine the reserved radio resources and prevent transmission during the reservation. Note that the radio resources of the CTS message may differ from the radio resources requested in the RTS message in case the recipient node cannot reserve all the requested resources. The CTS message may further comprise an information element indicating a modulation and coding scheme for the data transmission. This may be computed as a result of the channel estimation. The CTS message may also comprise information related to the collision handling and avoidance.

Successful radio resource reservation procedure reserves data/control resources for the transmitter node and the recipient node. When the procedure fails as a result of collision, for example, the network node may retry the procedure. The network node may scan for radio resources in a preliminary manner and, thus, determine available radio resources the network node proposes for its data transmission in the RTS message. This scanning may be purely randomized scanning or it may be controlled, for example, by time and/or frequency sequences as well as priorities set by the master access point.

The RTS/CTS handshake is used to reserve time-frequency resources, e.g. frequency resources in certain frames, covering DL/forward link and/or UL/reverse link portions of the non-protected part of the frame structure. The network node sending the RTS acts as a “master” in the link, and it may require the allocation needs of the recipient node in addition to the allocation requests related to the data the network node itself needs. The recipient node of the link (“slave”) may, for example, send buffer status reports, scheduling requests and/or “happy bit” indications, based on which the “master” may request suitable allocation for the reverse link transmission. The “happy bit” may be understood as an indication from the recipient node that a previous allocation may be continued. The allocation determined by the RTS/CTS handshake is determined in units of individual frames. In addition, it is possible to request semi-persistent allocations with an RTS. Accordingly, the RTS message may comprise an information element indicating whether the requested reservation is a one-shot reservation or a semi-persistent reservation recurring for a determined number of times or until actively cancelled. There may be different maximum resource allocation duration values defined for example for different types or classes of data, access groups etc. to ensure that quality-of-service (QoS) requirements of different types of data will be satisfied.

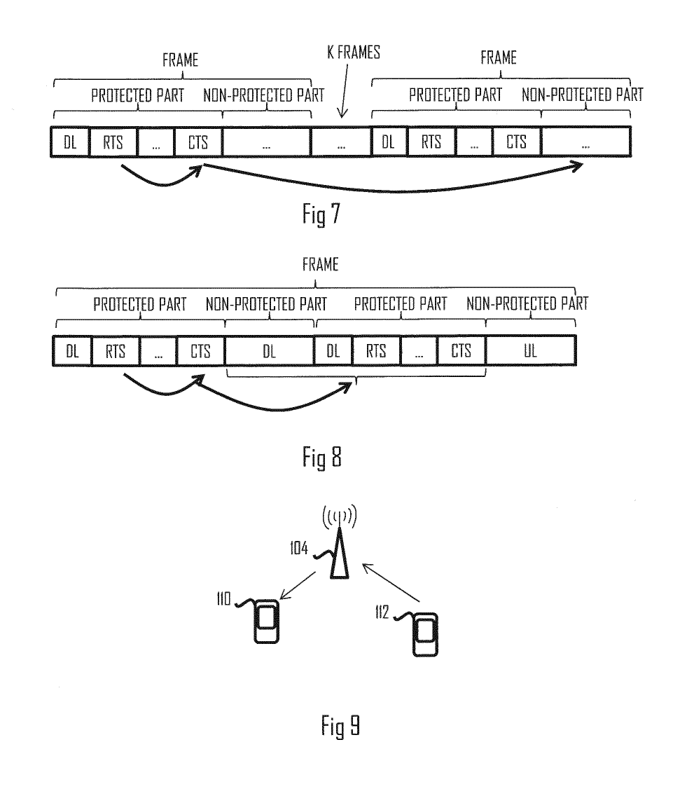

Let us now consider the reserved radio resources with respect to the RTS/CTS resources with reference to FIGS. 6 and 7. In the embodiment where the CTS message is transmitted in the same frame as in which the corresponding RTS message was transmitted, even the reserved radio resources may be provided in the same frame as the RTS and CTS message, e.g. in the non-protected part of the frame (FIG. 6).

In the embodiment where the CTS message is transmitted in a different frame than the RTS message, the reservation may be made to a frame which is different from the frame of the CTS message and from the frame of the RTS message. Accordingly, a determined time offset may be provided between the CTS message and the reserved radio resources. The time offset may be counted in frames or in another manner. The time offset may be preconfigured, e.g. the time offset may be fixed and counted from the time interval of the transmission of the CTS message. In another embodiment, the time offset may be indicated explicitly or implicitly in the CTS message.

FIG. 7 illustrates a combination of the above-mentioned embodiments. Referring to FIG. 7, the CTS message may be transmitted in the same frame as the corresponding RTS message, but the reserved resources may be located in a different frame, e.g. a determined number of frames after the frame of the RTS/CTS message.

In order to provide the recipient node with more time to process the RTS message while still providing a fast reservation procedure, the frame structure may be configured such that each frame comprises a plurality of protected parts, and the RTS message may be transmitted in a first protected part, while the CTS message is transmitted in a second protected part. FIG. 8 illustrates an embodiment of such a frame. Referring to FIG. 8, the frame may comprise the first protected part, a downlink non-protected part following the first protected part, the second protected following the downlink non-protected part, and an uplink non-protected part following the second protected part. As a consequence, the first protected part and the second protected part may be separated by at least one other part of the frame. The recipient node may be configured to respond to an RTS message received in the first protected part with a CTS message transmitted in the second protected part. This provides a longer time interval for processing the RTS message compared to that the recipient node should respond during the protected part of the RTS message. The sizes of the protected parts and the non-protected parts may be arranged such that the total combined size of the protected parts is still the same as the size of the protected part in FIG. 3, for example. As a consequence, the duration of the first protected part and the second protected part may be half of the duration of the protected part of FIG. 3. The total length of the protected in time may be about one fifth of the length of the non-protected part. For example, the length of the protected part may be 3 OFDMA symbols, while the length of the non-protected part may be 11 OFDMA symbols.

Analogously, if the recipient node receives the RTS message in the RTS resources of the second protected part, it may be configured to transmit the corresponding CTS message in the CTS resources of the first protected part of a subsequent frame.

In summary, the above-described embodiments cover the following options for exchanging the radio resource reservation messages and carrying out associated data transmission in the reserved radio resources: transmitting the request message, the response message, and the data all in the same frame; transmitting the request message and the response message in different frames but the response message and the data in the same frame; transmitting the request and response in the same frame by the data in a different frame, and transmitting the request, response and data all in different frames. Furthermore, it should be appreciated that while the above description with reference to FIGS. 3 to 8 relates to embodiments where the transmission resource of the radio resource reservation request is disposed in the downlink part of the protected part of the frame and where the transmission resource of the radio resource reservation acknowledgment is disposed in the uplink part of the protected part of the frame, in other embodiments the transmission resource of the radio resource reservation request is disposed in the uplink part of the protected part of the frame. The transmission resource of the radio resource reservation acknowledgment may accordingly be disposed in the downlink part of the protected part of the frame. If the downlink part precedes the uplink part in the protected part and if the radio resource reservation request is transmitted in the uplink part, the corresponding radio resource reservation acknowledgment may be transmitted in the downlink part of the subsequent frame or N frames after the frame of the radio resource reservation request.

As mentioned before, the radio resource reservation procedure described herein may be used to reserve the radio resource for unidirectional data transmission, or it may be used to reserve the radio resources for bidirectional data transmission, e.g. from the transmitter node to the recipient node and vice versa. In the latter case, the reservation may cover both downlink and uplink parts of the non-protected part of the frame structure. The frequency resources reserved for the downlink and uplink transmissions may be the same. However, the present reservation procedure may reserve separate uplink and downlink frequency resources. Accordingly, the RTS and CTS messages may comprise transmission-direction-specific information elements to indicate the resources reserved for uplink transmission (from the transmitter node to the recipient node) and for downlink transmission (from the recipient node to the transmitter node). Additionally, separate collision detection and collision handling procedures may be applied to the uplink and downlink transmission.

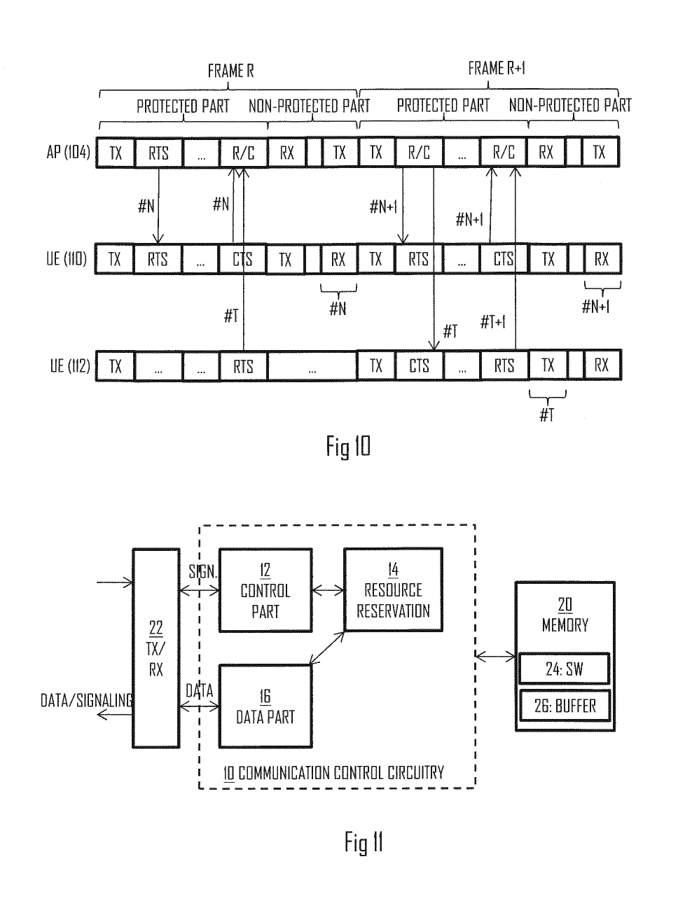

In the above-described embodiments, all the network nodes use the same time interval to gain access to transmit the RTS messages and CTS messages. Referring to FIG. 9, there may exist a problem, in which a network node transmitting an RTS message is not able to hear a simultaneously sent RTS message addressed to it. In this case, there is a data transmission from an access point 104 to a user terminal 110 and a simultaneous need to transmit data from a user terminal 112 to the access point 104. This situation equally applies to other scenarios, e.g. D2D transmissions. In other words, the access point 104 and the user terminal 112 initiate data transmission by sending the RTS messages to corresponding recipient nodes (the user terminal 110 and the access point 104). If the RTS messages are transmitted simultaneously the access point 104 does not detect the RTS transmitted by the user terminal 112, because its own transmission prevents the reception in a TDD system.

In an embodiment, there is detected a need for downlink data transmission from a network node to a recipient node and a need for uplink data transmission from a transmitter node to said network node. As a consequence, a transmission resource for the CTS message from the recipient node and a transmission resource for an RTS message from the transmitter node are arranged to the same time interval or arrange the resources to overlap at least partly. FIG. 10 illustrates this embodiment in connection with FIG. 9 in which the network node is the access point 104, the recipient node is the user terminal 110, and the transmitter node is the user terminal 112. Referring to FIG. 10, The access point may transmit an RTS message related to data transmission #N to the user terminal 110 in the protected part of frame R and receive a corresponding CTS message from the user terminal in the protected part of the same frame R. The user terminal 112 may use the CTS timing of the user terminal 110 as the RTS timing and, accordingly, transmit an RTS message related to data transmission #T to the access point. As a result, the access point is able to receive the CTS message related to the data transmission #N from the user terminal 110 and the RTS message related to the data transmission #T from the user terminal 112. Let us assume that the reservation related to the data transmission #N was successful and, as a consequence, resources from the subsequent downlink part of in the non-protected part of the frame R are reserved. The data transmission #N from the access point 104 to the user terminal may then be carried out in those resources.

During the next RTS/CTS timing, the access point 104 may transmit the CTS message related to the data transmission #T to the user terminal 112 and a new RTS message related to data transmission #N+1 to the user terminal 110. In case of successful reservation for data transmission #T, the data transmission may be carried out in the corresponding radio resources, e.g. in the non-protected part of the subsequent frame R+1. In this manner, the procedure may continue, and the access point is able to handle the uplink transmission with the user terminal 112 and the downlink transmission with the user terminal 110 as parallel processes that are both operational at the same time. This improves the efficiency of the data transmission in the wireless network. The procedure is directly applicable to the other embodiments described above.

The improvement may be realized by dividing, in a network node, neighbouring network nodes with which the network node transfers data into downlink nodes and uplink nodes. The downlink nodes are nodes to which the network node continuously transmits data, while uplink nodes are nodes from which the network node continuously receives data. The data transmission with these nodes may be at least mainly unidirectional. After the separation, the network node may assign interleaved RTS resources to the uplink nodes with respect to the downlink nodes such that the uplink nodes attempt to transmit the RTS messages at a different timing than the network node itself. Similarly, the network node may assign interleaved CTS resources to the uplink nodes with respect to the downlink nodes such that the downlink nodes attempt to transmit the CTS messages at a different timing than the network node itself. Furthermore, the RTS resources of the uplink nodes may have the same timing as the CTS resources of the downlink nodes. This procedure may be controlled by the master access point, or the network nodes may negotiate the RTS and CTS resources in a distributed manner.

On a system level, the improvement may be realized by providing combined resources for the RTS and CTS messages.

FIG. 11 illustrates an embodiment of an apparatus comprising means for carrying out the above-mentioned functionalities of the radio resource reservation procedure in a requesting device (the transmitter node) or a responding device (the recipient node). Depending on the situation, the apparatus may have the role of the transmitter node or the recipient node and, therefore, the apparatus may be provided with the capability of both roles. The apparatus may be a wireless apparatus which complies with specifications of a cellular communication system defined above or another wireless network. The wireless apparatus may also be a cognitive radio apparatus capable of adapting its operation to a changing radio environment, e.g. to select the RTS/CTS resources adaptively as described above in connection with FIG. 10. In embodiments where the wireless apparatus is comprised in a user terminal, the wireless apparatus may be or may be comprised in a computer (PC), a laptop, a tablet computer, a cellular phone, a palm computer, or any other user apparatus provided with radio communication capability. In another embodiment, the wireless apparatus is comprised in an access point which may be a base station of a cellular system or the access point of another wireless network. According to another aspect, the apparatus carrying out the above-described functionalities is comprised in such a wireless apparatus, e.g. the apparatus may comprise a circuitry, e.g. a chip, a processor, a micro controller, or a combination of such circuitries in the wireless apparatus.

Referring to FIG. 11, the apparatus may comprise a communication controller circuitry 10 configured to control wireless communications in the wireless apparatus. The communication controller circuitry 10 may comprise a control part 12 handling control signalling communication with respect to transmission, reception, and extraction of control messages including the radio resource reservation messages, e.g. the radio resource reservation request and radio resource reservation acknowledgment messages. The control part 12 may also carry out the above-described synchronization to the wireless network and to the frame structure of the wireless network. The control part 12 may also be configured to determine the resources for the radio resource reservation request and radio resource reservation acknowledgment messages. The control part 12 may further check the status of a data buffer and report a buffer status to another wireless apparatus as a part of control signalling. Accordingly, the other wireless apparatus may choose to reserve radio resources for bidirectional communication when the other wireless apparatus also has data to be transmitted to the wireless apparatus. Similarly, the control part 12 may receive buffer status reports from other wireless apparatuses and store the buffer status information in a memory 20. The communication controller circuitry 10 may further comprise a data part 16 that handles transmission and reception of payload data in the radio resources reserved according to the above-described manner and, optionally, in other radio resources as well. For example, the wireless apparatus may employ the above-described reservation procedure for one type of data transmission, while it uses resources scheduled by an access point, for example, for another type of data transmission.

The communication controller circuitry 10 may further comprise a radio resource reservation circuitry 14 configured to carry out the radio resource reservation procedure. From the point of view of the transmitter node, the radio resource reservation circuitry 14 may be configured to determine that a data buffer 26 comprises data to be transmitted to a recipient node. The radio resource reservation circuitry 14 may also check whether the buffer status information of the recipient node also indicates that the recipient node has data to be transmitted to the apparatus. If there is a chance for bidirectional data transmission, the radio resource reservation circuitry 14 may choose the reserve radio resources for bidirectional data transmission. Otherwise, the radio resource reservation circuitry 14 may choose to reserve radio resources for unidirectional data transmission. Then, the radio resource reservation circuitry 14 may output a command to the control part to transmit a radio resource reservation request message to the recipient node in the next appropriate resources. Upon receiving a radio resource reservation acknowledgment message, the control part 12 may forward the message to the radio resource reservation circuitry 14, and the radio resource reservation circuitry 14 may determine the reserved radio resources from the radio resource reservation acknowledgment message and instruct the data part 16 to carry out the data transmission and, optionally, reception in the reserved radio resources. Then, the data part may carry out the data transmission (and reception) in the reserved radio resources.

From the point of view of the recipient node, the radio resource reservation circuitry 14 may acquire a radio resource reservation request message received by the control part 12. The radio resource reservation circuitry 14 may then determine the radio resources to be reserved. In an embodiment where the radio resource reservation request indicates directly the radio resources requested for reservation, the radio resource reservation circuitry 14 may check whether or not the requested radio resources are available for reservation. This may be carry out by determining whether or not there are pending reservations on those resources and/or sensing those resources for radio signals. The sensing may be carried out as a normal procedure of the wireless apparatus, so there is no need to necessarily carry out the sensing in connection with every radio resource reservation request. Then, the radio resource reservation circuitry 14 may cause the control part 12 to transmit a radio resource reservation acknowledgment message indicating whether or not the reservation was fully successful, partially successful in the sense that some of the requested resources were reserved, or failed. In an embodiment where the radio resource reservation request comprises an information element not indicating directly the radio resources but, for example, a requested bandwidth or amount of data to be transferred, the radio resource reservation circuitry 14 may autonomously determine available radio resources to be reserved. Then, it may cause the control part 12 to transmit a radio resource reservation acknowledgment message comprising an information element indicating the requested resources, e.g. time-frequency resources in the form of PRB(s) and frame(s). The radio resource reservation circuitry 14 may also instruct the data part 16 to carry out the data reception and, optionally, transmission in the reserved radio resources. Then, the data part 16 may carry out the data reception (and transmission) in the reserved radio resources.

The circuitries 12 to 16 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 12 to 16 or all of them.

The apparatus may further comprise the memory 20 that stores computer programs (software) 24 configuring the apparatus to perform the above-described functionalities of the wireless apparatus. The memory 20 may also store communication parameters and other information needed for the wireless communications and in the reservation procedure, e.g. the resources for the request/acknowledgment messages. The apparatus may further comprise radio interface components 22 providing the apparatus with radio communication capabilities within the wireless network and in other wireless networks. The radio interface components 22 may comprise standard well-known components such as an amplifier, filter, frequency-converter, (de)modulator, and encoder/decoder circuitries and one or more antennas. In the embodiment where the apparatus is comprised in the user terminal, the apparatus may further comprise a user interface enabling interaction with the user of the communication device. The user interface may comprise a display, a keypad or a keyboard, a loudspeaker, etc.

In an embodiment, the apparatus carrying out the embodiments of the invention in the wireless apparatus comprises at least one processor and at least one memory including a computer program code, wherein the at least one memory and the computer program code are configured, with the at least one processor, to cause the apparatus to carry out the functionalities of the transmitter node and/or the recipient node according to any one of the processes of FIGS. 2 to 10. Accordingly, the at least one processor, the memory, and the computer program code form processing means for carrying out embodiments of the present invention in the wireless apparatus.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 2 to 10 may also be carried out in the form of a computer process defined by a computer program. The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to wireless networks defined above but also to other suitable wireless systems. The protocols used, the specifications of mobile telecommunication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method comprising:
causing a network node to synchronize to a frame structure of a wireless network, wherein the frame structure comprises a continuous flow of consecutive frames, wherein at least one frame comprises a downlink part and an uplink part, and wherein lengths of the downlink part and the uplink part in each frame are adjustable;
determining transmission resources for a radio resource reservation request in a frame of the frame structure;
causing transmission of the radio resource reservation request from the network node in the determined transmission resources, wherein the radio resource reservation request comprises an identifier of the network node and an identifier of a recipient node of the radio resource reservation request;
acquiring a radio resource reservation acknowledgment originated from the recipient node of the radio resource reservation request, wherein the radio resource reservation acknowledgment acknowledges reservation of radio resources for data transmission; and
in response to the radio resource reservation acknowledgment, causing data transmission in the reserved radio resources.

2. The method of claim 1, wherein each frame comprises a protected part and a non-protected part, wherein the protected part comprises dedicated resources for uplink transmission from user terminals to access points, for downlink transmission from access points to user terminals, for radio resource reservation requests, and for radio resource reservation acknowledgments.

3. The method of claim 2, wherein all active user terminals are obliged to carry out reception in the downlink transmission resources of the protected part, and wherein a subset of active user terminals is configured to carry out reception in the uplink transmission resources of the protected part.

4. The method of claim 2, wherein at least one of the frames comprises a plurality of protected parts and a plurality of non-protected parts.

5. The method of claim 1, further comprising: providing a radio link between the network node and a plurality of other network nodes; and selecting the recipient node from the plurality of other network nodes with which the radio link has been established.

6. (canceled)

7. The method of claim 1, wherein the reserved radio resources are used for bidirectional data transmission.

8. The method of claim 1, wherein guard intervals are arranged at the beginning and at the end of the radio resource reservation request, wherein the guard intervals are longer than corresponding guard intervals of at least one other control message transmitted by the network node.

9.-15. (canceled)

16. A method comprising:
causing a network node to synchronize to a frame structure of a wireless network, wherein the frame structure comprises a continuous flow of consecutive frames, wherein at least one frame comprises a downlink part and an uplink part, and wherein lengths of the downlink part and the uplink part in each frame are adjustable;
determining transmission resources for a radio resource reservation request in a frame of the frame structure;
acquiring a radio resource reservation request originated from a transmitter node and transferred in the determined transmission resources, wherein the radio resource reservation request comprises an identifier of the network node and an identifier of the transmitter node;
causing transmission of a radio resource reservation acknowledgment to the transmitter node in response to the acquired radio resource reservation request, wherein the radio resource reservation acknowledgment acknowledges reservation of radio resources for data transmission; and
in response to the radio resource reservation acknowledgment, causing data reception in the reserved radio resources.

17.-19. (canceled)

20. The method of claim 16, wherein the reserved radio resources are used for bidirectional data transmission.

21. The method of claim 16, further comprising attempting the transmission of the radio resource reservation acknowledgment in the same frame in which the radio resource reservation request was transferred.

22. The method of claim 16, wherein the data reception is arranged to occur in the same frame in which the radio resource reservation acknowledgment is transferred.

23. The method of claim 16, further comprising causing the transmission of the radio resource reservation acknowledgment in a frame subsequent to the frame in which the radio resource reservation request was transferred.

24. The method of claim 16, wherein the radio resource reservation request further comprises an information element indicating radio resources requested for reservation, wherein the radio resource reservation request acknowledges whether or not the requested radio resources have been reserved for the data transmission, and wherein the actual radio resource reservation is realized by the radio resource reservation acknowledgment.

25. The method of claim 16, wherein the radio resource reservation request comprises an information element specifying the radio resources requested for reservation, the method further comprising:
determining whether or not the requested radio resources are available for reservation from the point of view of the network node;
if the requested radio resources are available for reservation from the point of view of the network node, acknowledging the reservation of the requested resources with the radio resource reservation acknowledgment message; and
if only part of the requested radio resources are available for reservation from the point of view of the network node, acknowledging the reservation of the available resources with the radio resource reservation acknowledgment message and specifying the reserved radio resources in the radio resource reservation acknowledgment message.

26. The method of claim 16, further comprising:
autonomously selecting the radio resources for reservation in the network node; and
specifying the reserved radio resources to the transmitter node in the radio resource reservation acknowledgment message.

27.-29. (canceled)

30. An apparatus comprising:
at least one processor; and
at least one memory including a computer program code, wherein the at least one memory and the computer program code are configured, with the at least one processor, to cause the apparatus to:
cause a network node to synchronize to a frame structure of a wireless network, wherein the frame structure comprises a continuous flow of consecutive frames, wherein at least one frame comprises a downlink part and an uplink part, and wherein lengths of the downlink part and the uplink part in each frame are adjustable;
determine transmission resources for a radio resource reservation request in a frame of the frame structure;
cause transmission of the radio resource reservation request from the network node in the determined transmission resources, wherein the radio resource reservation request comprises an identifier of the network node and an identifier of a recipient node of the radio resource reservation request;
acquire a radio resource reservation acknowledgment originated from the recipient node of the radio resource reservation request, wherein the radio resource reservation acknowledgment acknowledges reservation of radio resources for data transmission; and
in response to the radio resource reservation acknowledgment, cause data transmission in the reserved radio resources.

31.-44. (canceled)

45. An apparatus comprising:
at least one processor; and
at least one memory including a computer program code, wherein the at least one memory and the computer program code are configured, with the at least one processor, to cause the apparatus to:
cause a network node to synchronize to a frame structure of a wireless network, wherein the frame structure comprises a continuous flow of consecutive frames, wherein at least one frame comprises a downlink part and an uplink part, and wherein lengths of the downlink part and the uplink part in each frame are adjustable;
determine transmission resources for a radio resource reservation request in a frame of the frame structure;
acquire a radio resource reservation request originated from a transmitter node and transferred in the determined transmission resources, wherein the radio resource reservation request comprises an identifier of the network node and an identifier of the transmitter node;
cause transmission of a radio resource reservation acknowledgment to the transmitter node in response to the acquired radio resource reservation request, wherein the radio resource reservation acknowledgment acknowledges reservation of radio resources for data transmission; and
in response to the radio resource reservation acknowledgment, cause data reception in the reserved radio resources.

46.-61. (canceled)
